(19) United States
(12) Patent Application Publication
(10) Pub. No.: US 2010/0065978 A1
(43) Pub. Date: Mar. 18, 2010

(54) METHOD FOR THE TREATMENT OF FISSURES IN CONCRETE STRUCTURES

(75) Inventor: José Vanderlei De Abreu, Sao Paulo (BR)

Correspondence Address: CHAPMAN AND CUTLER, 111 WEST MONROE STREET, CHICAGO, IL, 60603, US

(73) Assignee: Holcim Technology Ltd., Jona (CH)

(21) Appl. No.: 12/312,382

(22) PCT Filed: Oct. 23, 2007
(86) PCT No.: PCT/IB2007/003171

§ 371 Date: May 7, 2009

(30) Foreign Application Priority Data
Nov. 10, 2006 (BR) PI 0604778-5

(51) Int. Cl. B29C 73/02

(52) U.S. Cl. 264/36.2

(57) ABSTRACT

A method for the treatment of fissures in concrete structures by means of repairing them with microcement-based material, comprising a method wherein the fissures, both horizontal and vertical or inclined fissures, are identified and analyzed. The treatment of the mentioned horizontal fissures comprises cleaning them and drying their surface using compressed air and subsequently filling them by means of gravity, the grout being poured with the help of a “pset”. The vertical or inclined fissures are treated by demarcating the sites for drilling and inserting the injector nozzles that permit cleaning and saturating the fissures with water, followed by the injection of the microcement grout under pressure. (FIG. 1)

### FIELD OF THE INVENTION

The present invention relates to the corrective maintenance of concrete structures, particularly to the correction of fissures in floors, slabs, girders, and columns, among others.

### BACKGROUND OF THE ART

Whatever the field of activity we may be faced with in our everyday lives, globalization, accompanied by high technology, is incessantly aiming at overcoming certain technical/scientific problems in various sectors of industry and trade.

To this very day, issues relating to civil engineering, notably those that relate to the correction of fissures, cracks, faults, voids, etc., caused by the deterioration or by the stresses absorbed by the inner and outer structures of viaducts, slabs, buildings, pavements, tunnels, among others, lead to complications as regards filling them because, in addition to ramifications, they include irregular and deep surfaces that make the application of certain products difficult and impair their effectiveness.

With the aim of solving and improving such maintenance jobs, a range of products and methods has been developed, with a focus on high technology and low production costs, and progressively increasing the performance in terms of injection rheology, the resistance to extremely aggressive environments, and providing for good injectability in any application whatsoever, thereby bridging the gaps in this high technology market.

Various attempts at solving the problem of correcting cracks have been the object of a great number of patents which refer to this subject, for example: BR PI9302194-1, U.S. Pat. No. 3,102,829, WO2006038858, etc.

The document BR PI9302194-1 describes a method, comprising opening a channel by abrasion using a diamond grinding tool, into which channel an elastomeric profile is inserted; in this profile, a plurality of injector nozzles are introduced through which a polymeric resin is injected which penetrates into the cracks and fissures. This method is used to repair fissures in order to make them impermeable in a downward direction, although it requires additional operations such as opening the channel and using the elastomeric profile, which significantly complicates the method. In the case of non-rectilinear fissures, opening said channel requires greater dexterity on the part of the operator.

The document U.S. Pat. No. 3,102,829 describes a method that is applicable only to pieces of concrete having a smooth surface, to which two lateral plates, fastened to the surface of the concrete by means of vacuum, and one elongate central plate of smaller dimensions, provided with a gasket that is pressed over the crack and leaves only an entry orifice for it through which a polymeric resin is injected (the application method for the application of expoxies, methacrylate, and polyurethane is the same) are juxtaposed. Apart from being utilizable only on planar and smooth surfaces, the method is also burdened by the high costs of the resin.

The document WO 2006038858 describes, in contrast to those mentioned hereinabove, a method where the crack is filled with cement-based materials, the air being removed from the fissure before said cement is injected. The region of the crack is surrounded by a plate and a gasket which form a hermetically sealed system, in which a vacuum pump is applied for the partial removal of the air from inside the crack. Subsequently, the cement-based material is injected into the crack. The computerized control of operations is complex, thereby increasing the cost of the method.

### OBJECTS OF THE INVENTION

In view of the aforesaid, it is the object of the present invention to provide for the repair of fissures using low-cost materials and methods.

It constitutes another object of the invention to permit the filling of fissures in surfaces having non-planar forms.

It constitutes another object of the invention to permit the filling of fissures regardless of the conditions of the surface.

Another object of the invention is to dispense with the necessity of expensive equipment such as diamond grinding tools and computers for the control of the process.

It constitutes another object of the invention to provide for an increase of mechanical strength in the region of the fissure, in addition to filling the empty spaces.

Finally, it is another object of the invention to provide means in order to ensure that the empty spaces are filled completely.

### SUMMARY OF THE INVENTION

The above-cited objects as well as others are accomplished by the invention by utilizing microcement grouts, this material offering great versatility due its suitability for various injection methods and to its hydraulic properties, i.e., when reacting in the presence of water, it crystallizes and becomes a rigid product of high strength. This property imparts to the microcement the ability of attaching itself between the fissures of small cavities, in addition to being utilized as main raw material in the case of bridging by adhesion, it itself being the active agent of all applications employing it.

According to another feature of the invention, the fissures and cracks are treated by means of methods suitable for the orientation of the surfaces they are located on, they being horizontal, vertical, or inclined.

According to another feature of the invention, the fissures in horizontal surfaces are filled by gravity following previous cleaning.

According to another feature of the invention, the fissures in vertical or inclined surfaces are filled by means of injecting the grout through injector nozzles.

According to another feature of the invention, said injector nozzles are, following previous drilling, inserted obliquely to the surface with the help of punches.

According to another feature of the invention, said vertical or inclined fissures are sealed and covered at the surface using fast curing material.

### DESCRIPTION OF THE FIGURES

The various advantages and features of the method of repairing fissures with microcement under controlled pressure set forth herein can be better understood with reference to the description of preferred embodiments and the figures they relate to, wherein:

FIG. 1 shows the method for the treatment of fissures in horizontal surfaces by means of a flow diagram;

FIG. 2 shows the method for the treatment of fissures in vertical or inclined surfaces by means of a flow diagram;

FIG. 3 is a schematic perspective view of the insertion of the injector nozzles;

FIG. 4 shows, by means of a sectional view, the injection of the grout into a fissure.

### DETAILED DESCRIPTION OF THE INVENTION

In general terms, the method for the injection of microcement into fissures comprises two distinct scenarios distinguished by the orientation of the surface to be treated (horizontal and vertical/inclined surfaces) and principally by the use of injector nozzles that are not utilized for the treatment of horizontal surfaces. The identification of the target area of the treatment can be performed in two basic manners, i.e., by visual inspection and by using deflectometers.

In the first case, if we are dealing with warped floors, a percussion instrument can be utilized. The deflectometer is utilized in the treatment of specific structures such as floors in order to identify the differential settlement.

In the case of horizontal surfaces, the injector nozzles are not used, filling being performed by gravity, the grout being poured with the help of a “pset”. These are bottles of flexible plastic material having a cylindrical form and a graduated scale in order to control the volume of processed and applied liquid. It also includes a plastic cap which can be screwed onto the body and a flexible extension piece which renders it possible to direct and funnel the discharge of the liquid in the form of a strip, thereby facilitating its application to the fissures.

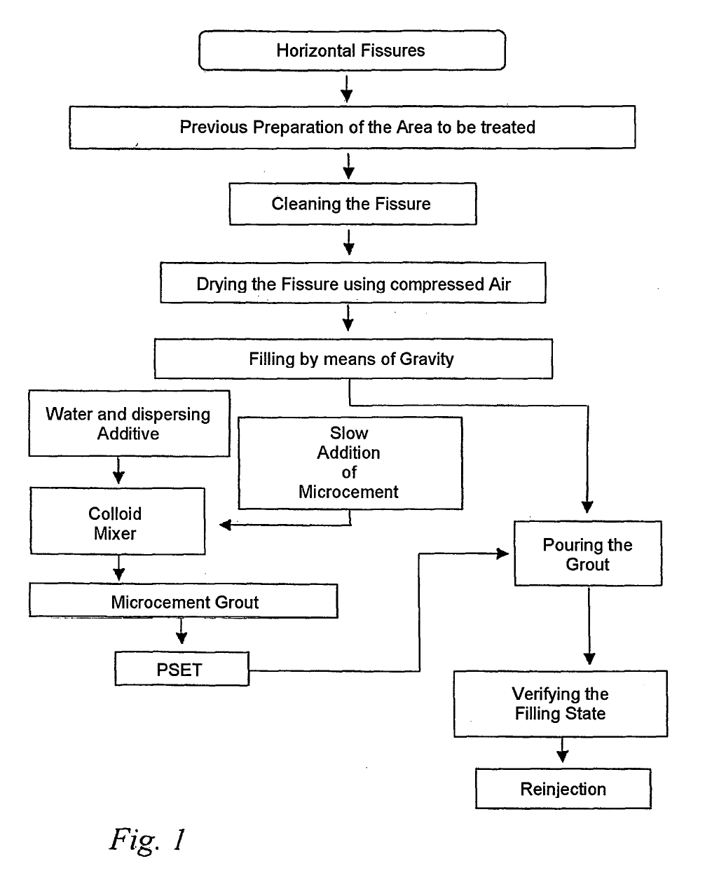

As indicated in the flow diagram of FIG. 1, the fissure is first cleaned by cleaning with pressurized water such that its inner surface is washed using a high-pressure water jet in order to eliminate existing undesired materials in its interior and to achieve its total decontamination, followed by drying its surface using compressed air.

The water and the microcement grout have, when being compared, different densities and viscosities, which permits the elimination of residual water contained in the fissures during the injection of the grout. Said elimination is made possible by the fact that the microcement grout is denser and more viscous than the water, thus occupying the area to be treated and expelling the water contained in the fissure without contaminating and compromising the process.

The mentioned filling takes place after said cleaning, the microcement grout being poured over the fissure by means of gravity, the expulsion being verified visually based on the overflow at the fissure. With the aim of ensuring that the fissure is filled completely, the process can be repeated once or several times until the fissure has been fully repaired.

In the treatment of vertical or inclined surfaces, the microcement injection method includes the following steps:
(a) previous preparing the area to be treated;
(b) demarcating the sites for the insertion of the injector nozzles and drilling of the concrete;
(c) inserting said injector nozzles with the help of appropriate punches;
(d) cleaning and saturating the fissure with water;
(e) sequential injecting of the grout through the injector nozzles;
(f) verifying the expulsion of the grout via the injector nozzles.

The feasibility of the treatment set forth herein is related to the characteristics of the area to be treated, its application not being possible in the event of fissures having a width smaller than 0.3 mm. Said treatment becomes feasible with greater widths.

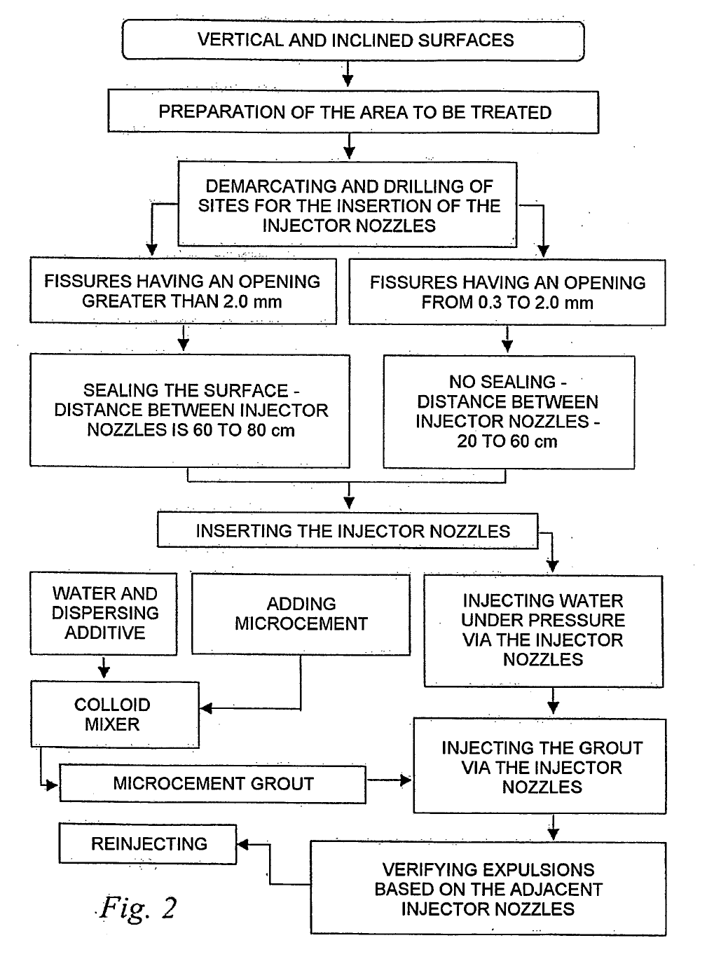

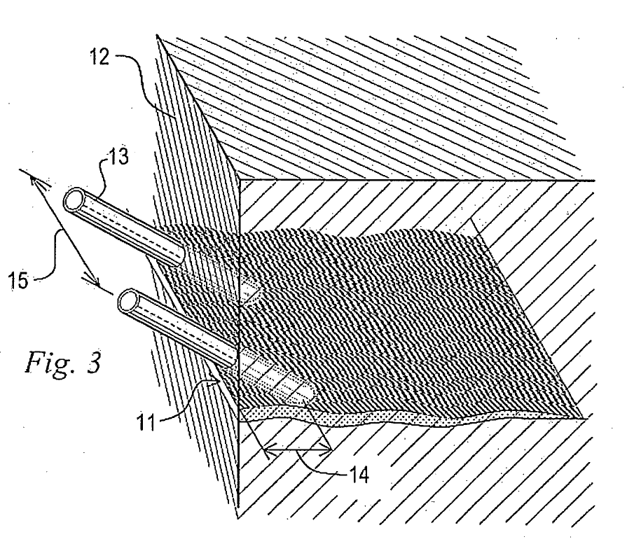

According to the invention and in conformity with the flow diagram of FIG. 2, the sites for drilling and for the subsequent insertion of the injector nozzles (covers) are demarcated, which are installed obliquely to the surface to be treated, the point of insertion not coinciding with the fissure. FIG. 3 shows schematically the positioning of the injector nozzles 13 in relation to a fissure 11 located in a vertical surface 12. As shown, these nozzles are not applied perpendicularly to said surface, but form an angle with it, the depth of the respective bore holes being sufficient to reach the fissure at a depth 14.

The spacing 15 of said bore holes and corresponding injector nozzles depends on the width of the fissure. For fissures having a width of 0.3 mm, this spacing is 20 cm, increasing proportionally to 60 cm for fissures no greater than 2.0 mm. Above this value, the previous sealing of the surface with fast curing cement-containing or chemical material is necessary, whereby in such case the distance between the bore holes can increase up to 80 cm.

After the mentioned process of demarcation, drilling, and applying the nozzles, the area to be treated is subjected to a cleaning and internal saturation process using water.

In the treatment of fissures by means of injection under pressure with the application of the injector nozzles, cleaning is performed by injecting water under moderate pressure (normally between 2.5 kgf/cm² and 4.0 kgf/cm²) through the same, before we inject the previously prepared grout.

The preparation of the grout is started by placing water and dispersing additive into a colloid mixer. Then, the microcement is gradually poured out, while the mixer is always kept in motion.

Said dispersing additive is a melamine-resin-based liquid super-plastifier having a variable density from 1.19 to 1.23 g/cm³ and a solids content from 35 to 39%. Its use provides for increased final and initial strengths as well as a low permeability and a high durability. Of the additives available, the present method preferably employs Rheobuild 2000PF produced by Degussa.

The utilized water/microcement ratio depends in part on the width of the fissure and varies between 0.45 and 0.55, the fluidity of the grout being adjusted with the help of the dispersing additive; however, the ideal fluidity for fissures having a small opening varies between 25 and 35 seconds with the modified Marsh cone.

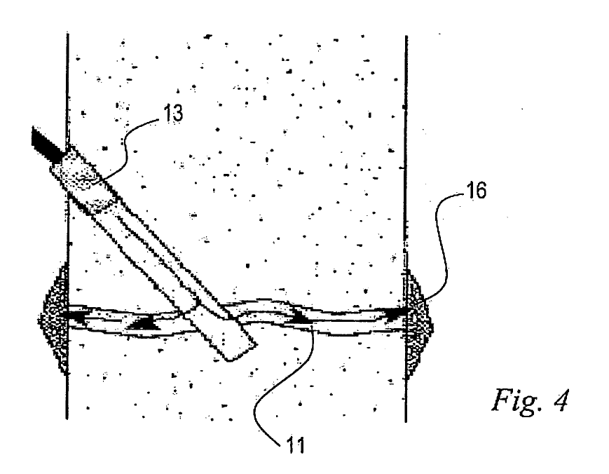

The injection of the grout is initiated by first using a pressure of 2 kgf/cm² and during which the expulsions are verified based on the adjacent injector nozzles or based on the discharge of the grout at the surface of the fissure, as referenced by 16 in FIG. 4. If necessary, the pressure can be increased, until expulsion occurs. For verification based on the adjacent injector nozzles, the non-return valve disposed in the interior of such nozzles must be unblocked in order to provide for relief of the pressure of the flow in the opposite direction (from inside to the outside) so as to ascertain that the fissure has been filled. The absence of grout being discharged by an adjacent injector nozzle indicates that there exists an obstruction in the fissure between the injector nozzles.

After the completion of the process at the last injector nozzle, the process continues with the reinjection along the fissures in order to ensure and correct possible faults, thus providing for a total repair of the fissure.

1-12. (canceled)

13. A method for treatment of fissures in concrete structures by repair with microcement-based materials, comprising the steps of:
preparing an area of a concrete structure containing a fissure to be treated;
filling the fissure with microcement grout;
visually verifying a filled state of the fissure; and
refilling the grout until the filled state of the fissure is verified.

14. The method as claimed in claim 13, wherein the area is on a horizontal surface of the concrete structure, and the preparing step comprises cleaning the area using pressurized water, and then drying the area using compressed air.

15. The method as claimed in claim 13, wherein the filling step is performed by means of gravity, and the grout is poured over the fissure by use of a pset.

16. The method as claimed in claim 13, wherein the fissure is disposed on a vertical or inclined surface of the concrete structure, and the preparing step comprises the steps of:
demarcating sites for inserting injector nozzles into the concrete structure,
drilling the demarcation sites for insertion of the injector nozzles, and
inserting the injector nozzles into the drilled sites.

17. The method as claimed in claim 16, wherein a distance between the demarcation sites is between 20 and 60 cm, and a width of the fissure is between 0.3 and 2.0 mm.

18. The method as claimed in claim 16, wherein a width of the fissure is greater than 2.0 mm, and further comprising the step of sealing a surface of the fissure with fast curing material.

19. The method as claimed in claim 16, wherein the injector nozzles are inserted obliquely to the surface of the concrete structure.

20. The method as claimed in claim 16, wherein the preparing step further comprises, after the step of inserting the injector nozzles, injecting water under pressure through the injector nozzles.

21. The method as claimed in claim 16, wherein the filling step comprises filling the fissure by injecting grout under pressure through the injector nozzles.

22. The method as claimed in claim 13, wherein the verifying step is performed by observing expulsion of the grout.

23. The method as claimed in claim 22, wherein the area is on a horizontal surface of the concrete structure, and wherein the observing step comprises observing an overflow of grout at the fissure in the horizontal surface.

24. The method as claimed in claim 21, wherein the verifying step is performed by observing discharge of the grout via a first one of the injector nozzles that is adjacent to a second one of the injector nozzles.

25. The method as claimed in claim 14, wherein the filling step is performed by means of gravity, and the grout is poured over the fissure by use of a pset.

26. The method as claimed in claim 17, wherein the preparing step further comprises, after the step of inserting the injector nozzles, injecting water under pressure through the injector nozzles.

27. The method as claimed in claim 18, wherein the preparing step further comprises, after the step of inserting the injector nozzles, injecting water under pressure through the injector nozzles.

28. The method as claimed in claim 19, wherein the preparing step further comprises, after the step of inserting the injector nozzles, injecting water under pressure through the injector nozzles.

29. The method as claimed in claim 15, wherein the verifying step is performed by observing expulsion of the grout.
